(19) United States
(12) Patent Application Publication
(10) Pub. No.: US 2014/0289180 A1
(43) Pub. Date: Sep. 25, 2014

(54) AUTOMATED GENERATION OF NEW WORK PRODUCTS AND WORK PLANS

(71) Applicant: International Business Machines Corporation, Armonk, NY (US)

(72) Inventors: Florian Pinel, New York, NY (US); Lav R. Varshney, Yorktown Heights, NY (US)

(73) Assignee: International Business Machines Corporation, Armonk, NY (US)

(21) Appl. No.: 13/902,314

(22) Filed: May 24, 2013

Related U.S. Application Data
(63) Continuation of application No. 13/847,099, filed on Mar. 19, 2013.

(51) Int. Cl. G06N 5/02

(52) U.S. Cl. CPC G06N 5/02
USPC 706/46

(57) ABSTRACT

An apparatus comprises a memory and a processor device operatively coupled to the memory. The processor device is configured to select one or more constituents and one or more classes of work products, analyze one or more existing work products to identify constituents frequently combined with the selected constituents and to identify constituents frequently used to create work products in the selected classes, determine a set of constraints for combining constituents for the set of classes based at least in part on a result of the analyzing step and generate one or more new work products in the set of classes using the set of constraints.

### CROSS-REFERENCE TO RELATED APPLICATIONS

This application is a Continuation of U.S. patent application Ser. No. 13/847,099, filed on Mar. 19, 2013, which claims the benefit of U.S. Provisional Application No. 61/746,317, filed on Dec. 27, 2012. The disclosures of these applications are incorporated by reference herein.

### FIELD

The field relates to computational creativity and, more particular to techniques for generation of work products and work plans.

### BACKGROUND

Fabrications of material and abstract objects may be facilitated or automated using computer programs. Computer programs and other machinery will use a work plan, or a process that realizes a work product, to facilitate the fabrication of material and abstract objects. Material objects include, by way of example, manufactured goods such as electronic circuits, food products, pharmaceuticals, etc. Abstract objects include, by way of example, complex travel itineraries, financial portfolios, culinary recipes, etc.

Fabrication of existing work products is or can be automated or facilitated by computer programs, but the creation of new work products and the development of new work plans are not automated.

### SUMMARY

According to one embodiment of the invention, an apparatus comprises a memory and a processor device operatively coupled to the memory. The processor device is configured to select one or more constituents and one or more classes of work products, analyze one or more existing work products to identify constituents frequently combined with the selected constituents and to identify constituents frequently used to create work products in the selected classes, determine a set of constraints for combining constituents for the set of classes based at least in part on a result of the analyzing step and generate one or more new work products in the set of classes using the set of constraints.

According to another embodiment of the invention, an article of manufacture comprises a computer readable storage medium for storing computer readable program code. The computer readable program code, when executed, causes a computer to select one or more constituents and one or more classes of work products, analyze one or more existing work products to identify constituents frequently combined with the selected constituents and to identify constituents frequently used to create work products in the selected classes, determine a set of constraints for combining constituents for the set of classes based at least in part on a result of the analyzing step and generate one or more new work products in the set of classes using the set of constraints.

These and other embodiments of the invention will become apparent from the following detailed description of illustrative embodiments thereof, which is to be read in connection with the accompanying drawings.

### BRIEF DESCRIPTION OF THE DRAWINGS

FIG. 1 illustrates a system for work product planning and design, according to an embodiment of the invention.

FIG. 2 illustrates a set of work products and classifications, according to an embodiment of the invention.

FIG. 3 illustrates an example of work products and classifications, according to an embodiment of the invention.

FIG. 4 illustrates another example of work products and classifications, according to an embodiment of the invention.

FIG. 5 illustrates a work plan, according to an embodiment of the invention.

FIG. 6 illustrates an example of a work plan, according to an embodiment of the invention.

FIG. 7 illustrates another example of a work plan, according to an embodiment of the invention.

FIG. 8 illustrates a further example of a work plan, according to an embodiment of the invention.

FIG. 9 illustrates grouping of constituents and actions into classes, according to an embodiment of the invention.

FIG. 10 illustrates an example of constituent and action class groupings, according to an embodiment of the invention.

FIG. 11 illustrates a methodology for automated generation of new work products, according to an embodiment of the invention.

FIG. 12 illustrates another methodology for automated generation of new work products, according to an embodiment of the invention.

FIG. 13 illustrates a methodology for automated generation of work plans for new work products, according to an embodiment of the invention.

FIG. 14 illustrates another methodology for automated generation of work plans for new work products, according to an embodiment of the invention.

FIG. 15 illustrates sub-graph combination in work plan generation, according to an embodiment of the invention.

FIG. 16 illustrates a computing device in accordance with which one or more components/steps of techniques of the invention may be implemented, according to an embodiment of the invention.

### DETAILED DESCRIPTION

Illustrative embodiments of the invention may be described herein in the context of an illustrative methods, systems and devices for new work product and work plan generation. However, it is to be understood that embodiments of the invention are not limited to the illustrative methods, systems and devices described but instead are more broadly applicable to other suitable methods, systems and devices.

As used herein, the term “work product” is used to refer to an object—material or abstract—that was produced by following a process. Work products include manufactured goods such as electronic circuits, food products, and pharmaceuticals, as well as patents, culinary recipes, complex travel itineraries, and financial portfolios.

As used herein, the term “work plan” is used to refer to a process that realizes a work product.

While the fabrication of existing work products is or can be automated or facilitated by computer programs, the generation of new work products and the creation of the work plans that realize them are performed by humans. Human resources, however, represent a finite quantity which limits the amount of new work products that can be created and realized. In some areas, the volume of work products is the key to success, whether it is an end in itself or a means to achieve better results. Advantageously, embodiments of the invention provide methods, systems and apparatus for automatically generating new work products that are novel and high-quality be recombining inspirational examples from a knowledge database. Embodiments of the invention also provide for the creation of work plans for realizing the new work products.

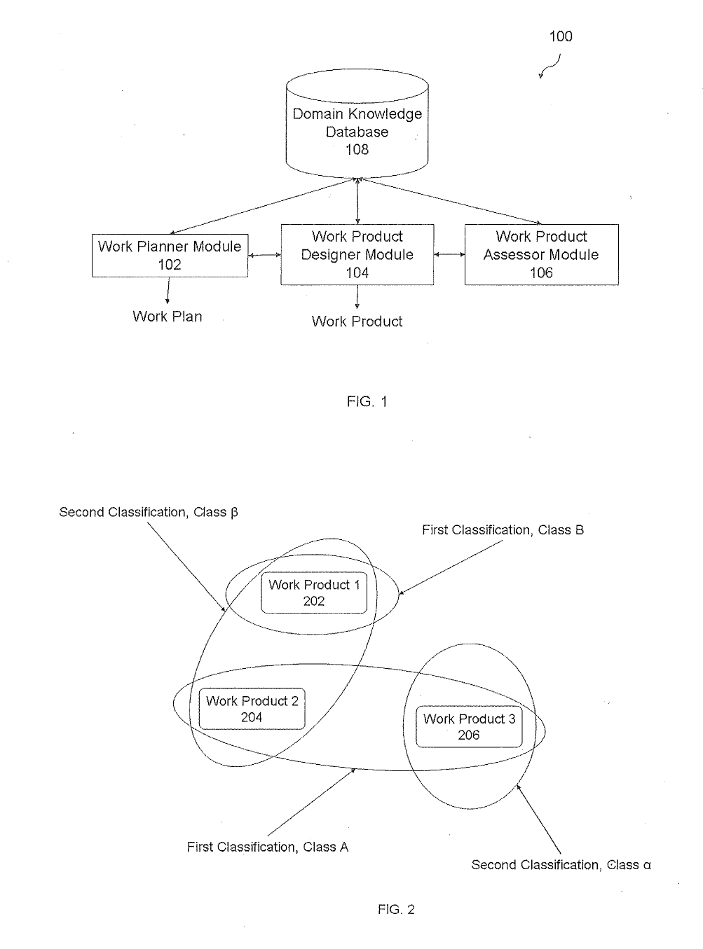

FIG. 1 illustrates a system 100 for work planning and design. The system includes a domain knowledge database 108, a work planner module 102, a work product designer module 104 and a work product assessor module 106. The work planner module 102 is configured to generate work plans for new work products designed in the work product designer module 104. The work product assessor module 106 is configured to evaluate new work products and work plans for the new work products. The work planner module 102, work product designer module 104 and work product assessor module 106 are configured to exchange information with one another and retrieve and store information from the domain knowledge database 108 to create new work products and corresponding work plans for the new work products.

The domain knowledge database 108 stores information relating to existing work products. This information may include lists of constituents in existing work products, work plans for existing work products, and various other information relating to work products and work plans. For example, the domain knowledge database 108 may contain information relating to constraints for creating work products and work plans. The domain knowledge database 108 may also contain information relating to user evaluations and feedback for work products and work plans.

In some embodiments, the domain knowledge database 108 includes a dataset of inspirational examples of work products, with lists of the parts or elements in the work products and information relating to the cost, nature and availability of the parts and elements. For example, the domain knowledge database may contain information relating to the chemical composition of pharmaceuticals, food ingredients, material types, etc. as well as the costs, availability, etc. of these parts and elements. Such parts and elements are examples of what is more generally referred to herein as constituents. The domain knowledge database 108 may further include lists of techniques for creating existing work products, including the costs of such techniques. The cost may include the time required to build the work product (i.e., computational time for compiling a computer program, labor time for performing construction tasks, the cost of equipment required for construction, compiling, etc.) In addition, the domain knowledge database 108 may include historical data on quality assessments, such as human hedonic perception data or patent licensing value data.

Existing work products in the domain knowledge database 108 can be clustered into categories using one or more dimensions. FIG. 2 shows an example of work product clustering. FIG. 2 shows work product 1 202, work product 2 204 and work product 3 206. Each work product has first and second classifications. In FIG. 2, work product 1 202 and work product 2 204 have different first classifications (B and A, respectively) but the same second classification, class β. Work product 2 204 and work product 3 206 have the same first classifications, class A, but different second classifications (β and α, respectively).

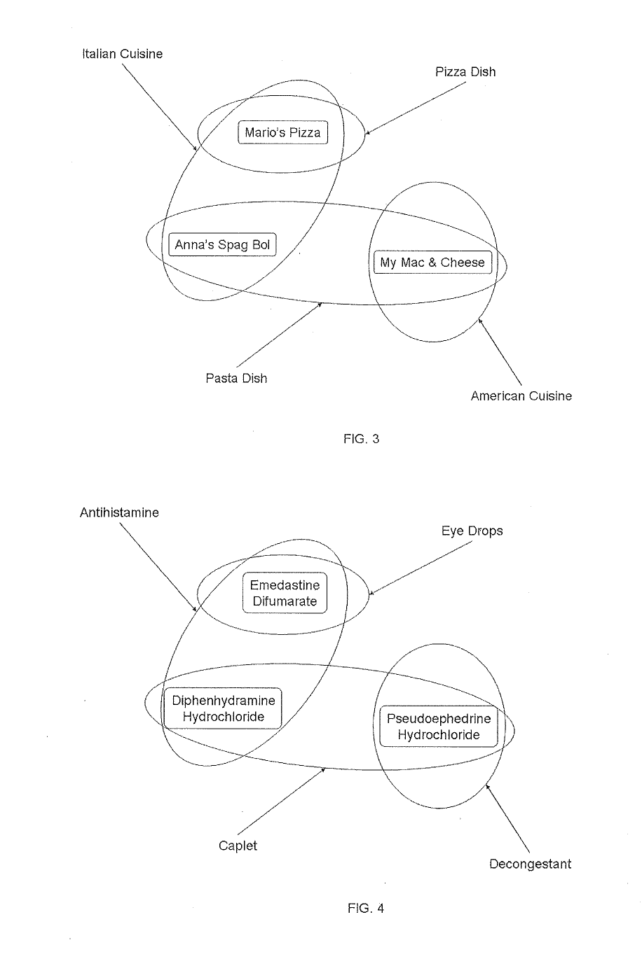

FIGS. 3 and 4 show two examples of work product clustering for specific application areas. In FIG. 3, the application area is in culinary recipe generation, with the work products being finished food dishes and the work plans being recipes for creating the dishes. FIG. 3 shows three food dishes: Mario's Pizza, Anna's Spag Bol and My Mac & Cheese. Mario's Pizza has a first classification as a pizza dish and a second classification as Italian Cuisine. Anna's Spag Bol has a first classification as a pasta dish and a second classification as Italian Cuisine. My Mac & Cheese has a first classification as a pasta dish and a second classification as American Cuisine. Thus, Mario's Pizza and Anna's Spag Bol faun a cluster under their second classification, Italian Cuisine, while Anna's Spag Bol and My Mac & Cheese form a cluster under their first classification, as pasta dishes.

In FIG. 4, the application area is in pharmaceutical design, with the work product being a medication and the work plan being a process for manufacturing the medications. FIG. 3 shows three medications: emedastine difumarate, diphenhydramine hydrochloride and pseudoephedrine hydrochloride. These medications are classified using two classes: effect and form. Thus, emedastine difumarate is classified as an antihistamine and eye drops, diphenhydramine hydrochloride is classified as an antihistamine and caplet, and pseudoephedrine hydrochloride is classified as a decongestant and caplet. Emadistine difumarate and diphenhydramine hydrochloride are clustered as antihistamines, while diphenhydramine and pseudoephedrine hydrochloride are clustered as caplets.

While FIGS. 3 and 4 show two specific examples of work product clustering, it is important to note that embodiments of the invention are not limited solely to the application areas of culinary recipe generation and pharmaceutical design as shown in FIGS. 3 and 4. Instead, embodiments of the invention are more generally applicable to a wide variety of work product application areas. By way of example only, another application area is in fashion, wherein an outfit comprising a collection of clothing items, jewelry, make-up, etc. is the work product, with the work plan being a process for acquiring or assembling the outfit using item's already in one's closet or possession, using new acquisitions, etc. One skilled in the art will readily appreciate that various other application areas are possible, including structure construction, travel itineraries, etc.

In addition, the application areas shown in FIGS. 3 and 4 are not limited solely to the classifications and work products shown in these figures, but instead may have a wide variety of other classifications and work products. Also, each work product may have more than two classifications, and some work products may have more or less classifications than other work products.

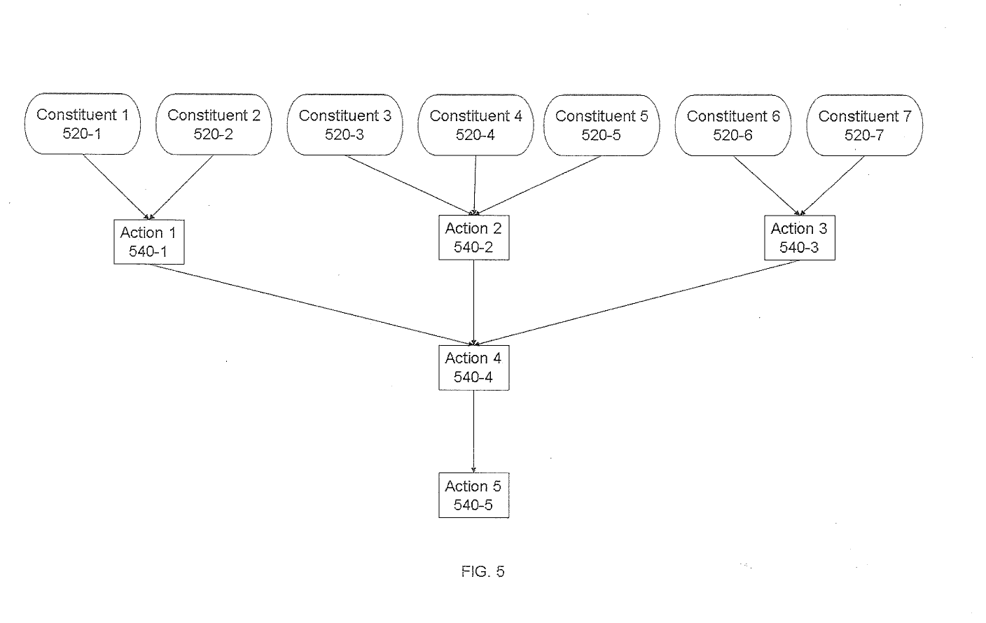

Existing work products in the domain knowledge database 108 have corresponding work plans describing the constituents and actions used to create the work products. FIG. 5 illustrates an example work plan, with constituents 1-7 520 and actions 1-5 540. Constituent 1 520-1 and constituent 2 520-2 are combined using action 1 540-1. Constituent 3 520-3, constituent 4 520-4 and constituent 5 520-5 are combined using action 2 540-2. Constituent 6 520-6 and constituent 7 520-7 are combined using action 3 540-3. The combinations of constituents formed using action 1 540-1, action 2 540-2 and action 3 540-3 are combined using action 4 540-4, and action 5 540-5 is subsequently applied to generate the work product.

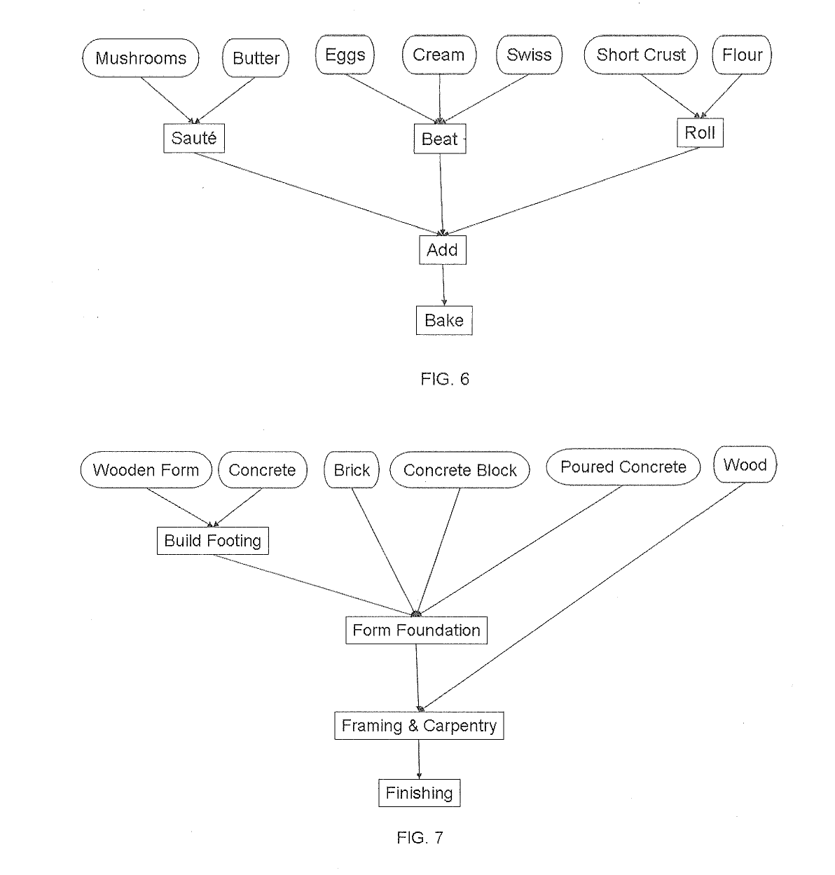

FIGS. 6-8 show examples of work plans for specific application areas. FIG. 6 shows a work plan in the application area of culinary recipe generation. In FIG. 6, the constituent mushrooms and butter are sautéed, the constituent eggs, cream and swiss cheese are beat and the constituent short crust and flour are rolled. These combinations are then added together and baked resulting in a quiche.

FIG. 7 shows a work plan in the application area of structure construction. The constituents of a wooden form and concrete are used to build a footing. The constituents of bricks, concrete blocks and poured concrete are combined with the footing to form a foundation. The foundation and constituent wood are combined with framing and carpentry. Finishing is applied to result in a structure such as a home.

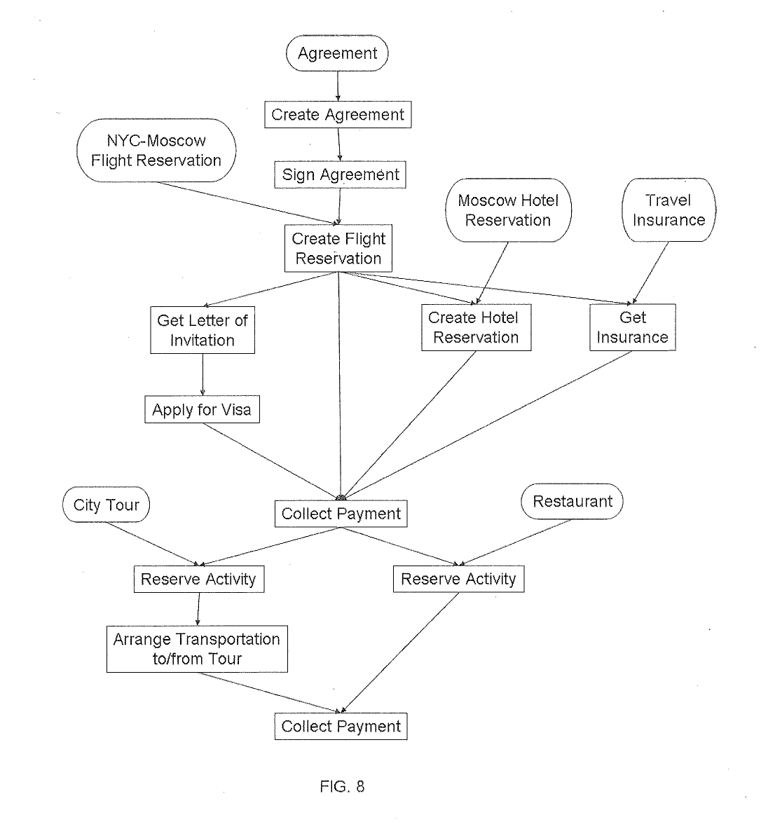

FIG. 8 is in the application area travel itineraries. The constituents of a flight reservation between New York City and Moscow, a booking agreement, a Moscow hotel reservation, travel insurance, a city tour and a restaurant are combined to generate a work plan for the travel itinerary. The booking agreement is created and signed with a travel service or agent, and a flight reservation is created. Using the created flight reservation, a hotel reservation is created using the Moscow hotel reservation constituent. The created flight reservation is also used with the travel insurance constituent to obtain travel insurance. The created flight reservation is further used for getting a letter of invitation, which is used to apply for a visa. Payment is collected for the visa application, hotel reservation, travel insurance and flight reservation. Next, a city tour and a restaurant are reserved. The reservation for the city tour is used to arrange transportation to and from the tour. Payment is collected for the city tour and the restaurant.

Again, it is important to note that embodiments of the invention are not limited solely to the application areas shown in FIGS. 6-8, but instead are more widely applicable to various other application areas. In addition, the work plans for the application areas in FIGS. 6-8 are not limited solely to the constituents and actions shown in these figures. Instead, a wide variety of other constituents and actions may be used in these application areas.

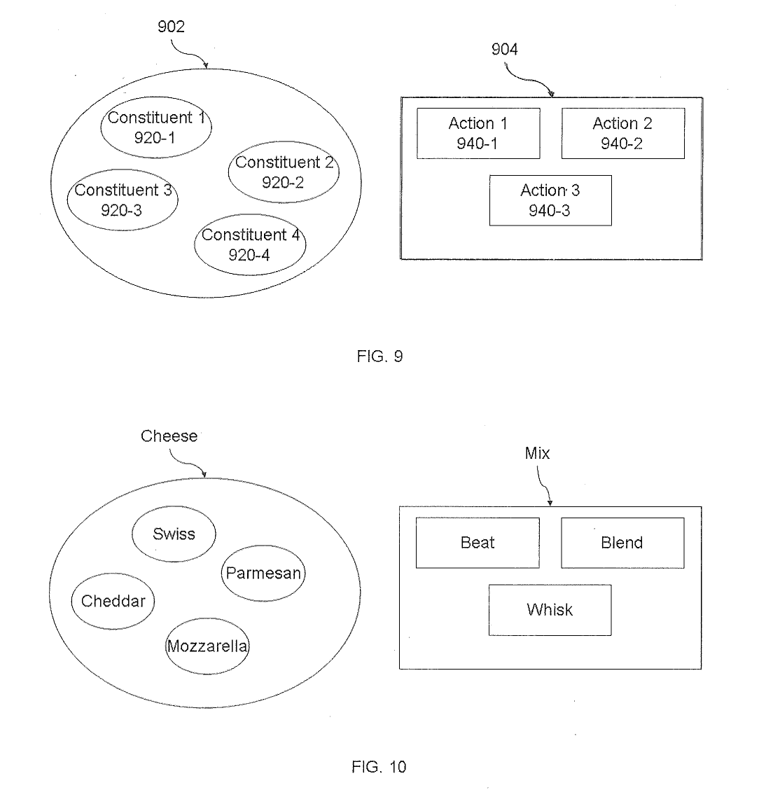

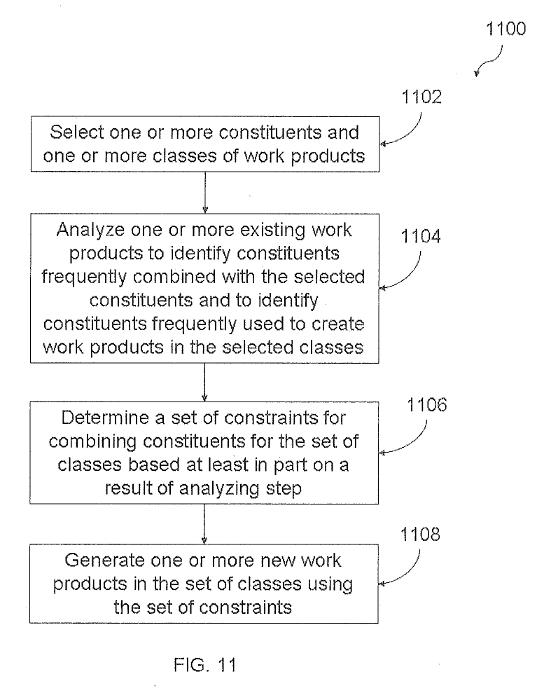

As with work products, constituents and actions may be clustered into classes. FIG. 9 shows an example of constituent and action clustering. Constituents 1-4 920 are clustered in constituent class 902, and actions 1-3 940 are clustered in action class 904. FIG. 10 shows an example of constituent class and action class clustering in the application area of culinary recipe generation. The constituents of swiss, cheddar, parmesan and mozzarella are clustered in the cheese constituent class. FIG. 10 also shows a mix action class comprising beat, blend and whisk actions. While not shown in FIG. 10, constituent and action classes may be subdivided. By way of example, the cheese constituent class may be grouped by color, cost, region, etc. Work product classes may be similarly subdivided.

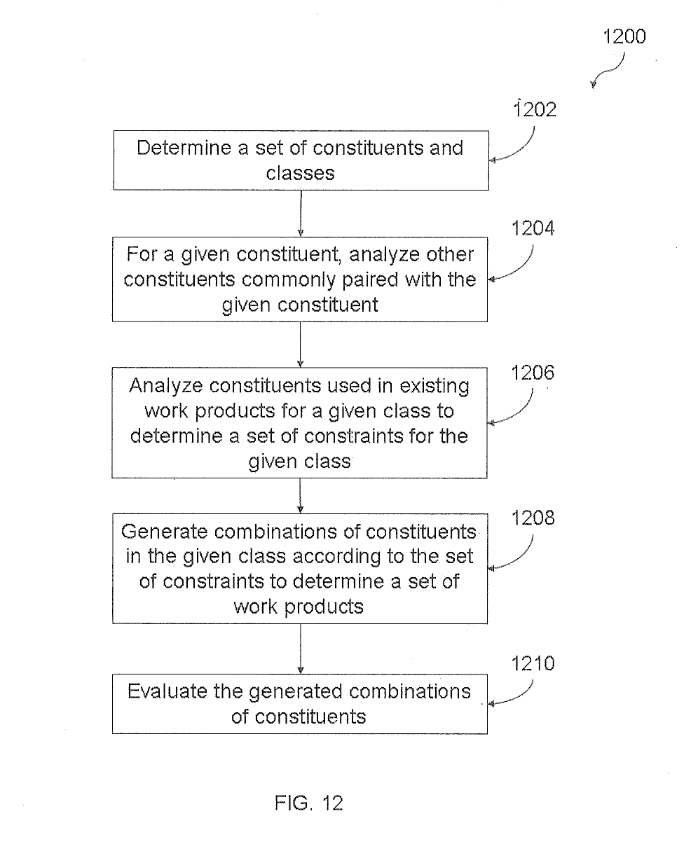

The work product designer module 104 in FIG. 1 may be configured to generate new work products using the methodology shown in FIG. 11 or FIG. 12. FIG. 11 shows a methodology 1100 for generating work products. Methodology 1100 begins with step 1102, selecting one or more constituents and one or more classes of work products. Next, in step 1104 one or more existing work products are analyzed to identify constituents frequently combined with the selected constituents and to identify constituents frequently used to create work products in the selected classes. A set of constraints for combining constituents for the set of classes is determined in step 1106 based at least in part on a result of the analyzing step 1104. In step 1108, one or more new work products in the selected set of classes are generated using the set of constraints.

A specific example of new work product generation will be described in conjunction with methodology 1200 shown in FIG. 12. Methodology 1200 starts with determining a set of constituents and classes 1202. For example, a user can select one or more constituents (e.g., salmon and butter) and one or more classes of work products (e.g., quiches and Norwegian food). In step 1204, other constituents which are commonly paired with a given constituent are analyzed. For example, existing work products in the domain knowledge database 108 may be analyzed to determine other constituents which are commonly paired with salmon in quiches and Norwegian food. Next, in step 1206, constituents used in existing work products in the domain knowledge database 108 are analyzed to determine a set of constraints for the given class. For example, existing work products may be analyzed to determine that in quiches, butter is commonly paired with some constituents but not others.

In step 1208, combinations of constituents in the given class or selected classes are generated to determine a set of work products. In some embodiments, all possible combinations are produced in step 1208. In other embodiments, only a specific number of combinations may be generated. The specific number may be static, dynamic, user-programmed, pre-programmed, etc.

In some embodiments, the work product assessor module 106 will evaluate the generated combinations of constituents in step 1210. The work product assessor module 106 can assign a rating to each generated work product. The work product assessor module 106 can use various assessments which may be domain or application-area specific. A user may also specify which assessments are performed for the generated work products. Assessments of generated work products may include cost, novelty, and quality assessments. It is important to note, however, that embodiments of the invention are not limited solely to these assessments.

The set of constraints used in methodologies 1100 and 1200 may be determined in a number of ways. In some embodiments the set of constraints may include a number of user-defined constraints. A user may choose how many constituents they want to have in the generated work product. A user may also select certain constituents which may not be used, which must be used, or which may be used in the alternative. For example, in generating a culinary recipe, a user may specify ingredients which may not be used because of a food allergy or other dietary restriction. A user may also select certain classes of constituents which may or may not be used in the generated work products. For example, a constraint may specify that a meat constituent class is excluded if the user wants to generate vegetarian dishes. As another example, a constraint may specify certain classes that must be excluded, or which or mutually exclusive for generating kosher foods. In addition, a user may specify a total cost of constituents for the generated work product or specify an availability of constituents. By way of example, a user may specify that only fruits or vegetables which are in season may be used in the generation of new work products.

In other embodiments, the set of constraints may include a number of constraints determined from existing work products. Analysis of existing work products may indicate that for a given class of work products, certain combinations or numbers of constituents should be used. As an example, a constraint may specify how many kinds of vegetables are included in quiches for culinary recipe generation. A constraint may also specify a relationship between constituents in two classes. For example, a constraint may specify that a specific number of vegetable constituents should be used for each meat constituent in quiches. It is important to note that the constraints do not need to be absolute. A constraint may specify an average number of constituents for a work product in a given class, along with a standard deviation. As an example, a constraint may specify that quiche recipes should contain 2 dairy products, with a standard deviation of 0.5. In addition, analysis of existing work products may be used to define mutually exclusive constituent classes. For example, a constraint may specify that quiche recipes which contain fish should not contain meat. Analysis of existing work products may also be used to define mutually inclusive constituent classes. By way of example, a constraint may specify that quiches should contain both vegetable and dairy constituents.

Constraints may also be determined from combinations of other constraints and data on existing work products. Analysis of existing work products may be used to set the numbers of constituents for each constituent class in generated work products. The average number of constituents may be used, unless a class is on a mutually exclusive class list of the five most frequent constituent classes in existing work products, in which case the number of constituents for that class is set to zero. One skilled in the art will readily appreciate that various other thresholds may be used, including threshold ranges rather than absolute thresholds.

In some embodiments, the constraints may limit the constituents used in the generated work product to the list of commonly used constituents for selected work product classes. For example, a constraint may specify that Norwegian dishes should contain dill, salmon, and onion but should not contain rosemary or olives. Other constraints, such as those described above, may simply set numbers of constituents per constituent class or work product class. As an example, a constraint may specify that a quiche should contain two dairy products, without specifying which dairy products may or may not be used.

It is important to note that the types and examples of constraints described above is not an exhaustive list of all possible constraints which may be used in embodiments of the invention. Instead, one skilled in the art will readily appreciate that various other constraints may be used, including combinations of the constraints described above. In addition, while various constraints described above relate to analysis of existing work products in the selected work product classes, constraints may also be determined based on the constituents and constituent classes selected by the user. For example, the set of constraints may determine that only a fixed list of ingredients may be paired with salmon based on existing recipes in all classes, or that salmon recipes may not contain certain ingredients such as chocolate, or that salmon recipes should contain between 1 and 4 types of vegetables.

Various constraints described above use the term “commonly” to describe relationships among constituents, constituent classes, work products, work product classes, etc. The term commonly refers to a frequency of occurrence. A frequency threshold may be used to distinguish what is common and what is not common. For example, if greater than 10% of the work products in a given work product class pair two constituents, the two constituents may be deemed to be commonly paired. It is important to note that various frequency thresholds may be used, which may be static, dynamic, user-programmed, pre-programmed, etc. In addition, frequency thresholds may be particular to a given constituent or work product class. Some constituent classes may include a relatively large number of constituents, while other constituent classes may include a relatively small number of constituents. Thus, the frequency threshold may vary for different classes. As an example, quiche work products may include a relatively large number of vegetables with a relatively small number of dairy products. Thus, the frequency threshold for dairy constituents may be higher than that of the frequency threshold for vegetable constituents.

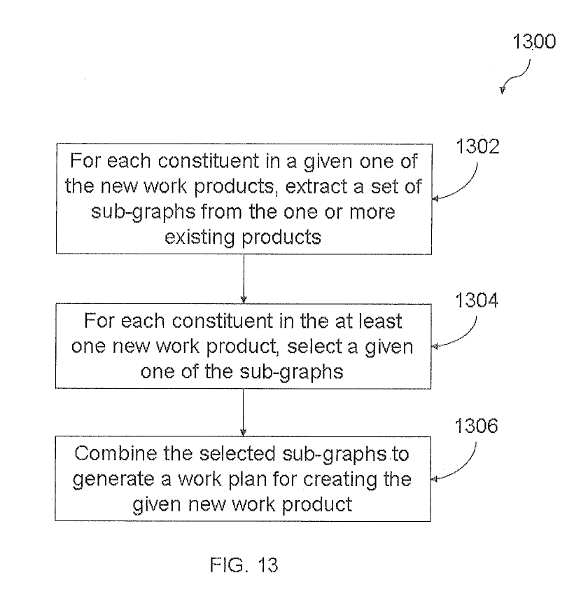

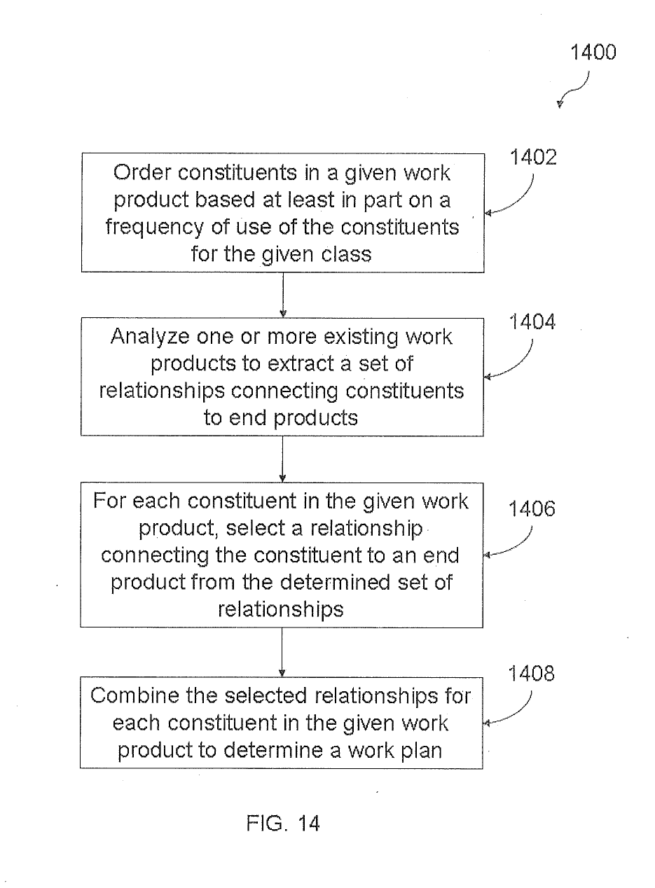

The work planner module 102 in FIG. 1 may be configured to generate work plans for new work products using the methodology shown in FIG. 13 or FIG. 14. FIG. 13 illustrates a methodology 1300 for work plan generation. The methodology 1300 begins with step 1302, where for each constituent in a given one of the new work products, a set of sub-graphs are extracted from one or more existing work products. Each existing work product in the domain knowledge database 108 may have an associated work plan, which may be represented by a graph of constituents and actions which connect a constituent to the end product. Sub-graphs may be extracted from the work plans in existing work plans. Each sub-graph may have a starting constituent, and include the actions which connect the starting constituent to the end product. More generally, a sub-graph identifies a relationship between a constituent and an end product, or a relationship between a constituent and an intermediate combination in the process of generating a work product.

The methodology 1300 continues with step 1304, where a given one of the sub-graphs is selected for each constituent in the at least one new work product. The sub-graphs may be grouped together in a variety of ways. For example, sub-graphs may be grouped by their starting constituents. Sub-graphs may alternatively or additionally be grouped based on a similarity in the sequence of actions in the sub-graphs. Sub-graph groups may contain sub-graphs which contain the same sequence of actions, or may contain sub-graphs with similar sequences of actions. In some embodiments, two or more sub-graphs are considered similar if a path edit distance between the sequences of actions in the sub-graphs is less than a distance threshold. Sub-graph groups may also be simplified to facilitate grouping. For example, if a sub-graph has two identical consecutive actions, these actions can be merged when grouping the sub-graph. In addition, sub-graphs may be grouped by similarity but not by starting constituent.

Step 1304 may comprise selecting a sub-graph group for the constituent, and selecting a representative sub-graph from the selected sub-graph group. The sub-graph group may be selected in a number of ways. For example, the sub-graph group may be selected based on the number of sub-graphs in the sub-graph group. The sub-graph group may alternatively be selected based on the average number of actions in sub-graphs of the sub-graph group. The sub-graph group with the least number of actions, or the most cost effective actions may alternatively be selected. The sub-graph group and representative sub-graph may also be selected subject to a set of constraints. A user may specify certain actions which should and should not be performed. For example a user may only have access to certain equipment, and thus the sub-graph group or representative sub-graph which is selected should not include actions which require other equipment. One skilled in the art will readily appreciate that a variety of other constraints may be used.

Once a sub-graph group is selected, a representative sub-graph in the sub-graph group is selected in step 1304. Similar to the sub-graph group, the representative sub-graph may be selected in a number of ways. For example, the representative sub-graph may be chosen based on the number of actions in the sub-graph. The representative sub-graph may also be the most common sub-graph in the sub-graph group. One skilled in the art will readily appreciate that the sub-graph group and representative sub-graph group may be selected using a variety of techniques, including combinations of the techniques described above.

In some embodiments, combining the selected sub-graphs in step 1406 may start with selecting a pair of constituents in the given new work product. The pair of constituents may be the most frequently used constituents in the work product classes. The pair of constituents may alternatively be chosen based on priority levels assigned to the constituent. For example, constituents and constituent classes may be categorized as primary and secondary classes. Primary classes may include constituents which are key to the generation of the work plan, while secondary classes act in a supporting role in generating the work plan. For example, in a quiche recipe the pie crust, fish and egg products are key and thus may be designated as primary classes or top priority constituents. The oil used to cook the vegetables in the quiche however, will not typically dictate the way in which the quiche is prepared as a whole. It is important to note that more than two priority levels may be used in embodiments of the invention.

Next, a determination is made as to whether the representative sub-graphs for the pair of constituents can be merged. If the representative sub-graphs for the selected pair of constituents can be merged, the pair of constituents is merged and the next pair of constituents is selected. A pair of sub-graphs can be merged when the sequences of actions in the pair of representative sub-graphs have a common merging action. Merging can only occur on certain actions of a sub-graph. For example, in culinary recipe work plans, the actions of adding or mixing may be used to merge two sub-graphs while the action of cutting or chopping may not merge two sub-graphs. If more than one merging action is available to merge two sub-graphs, the most frequent merging action may be used. Alternatively, the earliest merging action in the representative sub-graph for the highest priority constituent may be selected. Various other techniques may be used to select a merging action from a set of available merging actions.

If the representative sub-graphs for the pair of constituents cannot be merged, a new representative sub-graph may be selected for at least one constituent in the constituent pair. New representative sub-graphs may be selected until two sub-graphs can be merged or until a threshold number of combinations of sub-graphs has been tested.

In some embodiments, sub-graph merging may occur in several passes, such as one for each priority level. In a first pass, the sub-graphs for primary constituents or constituent classes are merged into a work plan as described above. In a second pass, the sub-graphs for the secondary constituent classes may be merged in a different manner. The representative sub-graphs may be selected based on the first merging action in the sub-graphs rather than the final work product in the sub-graphs. The sub-graph grouping for the second constituent classes can also take into account what primary classes were merged on the merging action. For example, a sub-graph for the oil ingredient class could by oil→heat→add, with the antecedent of add being a vegetable. The actions after add will typically have little to do with the oil, and more to do with the vegetable. Thus, the first merging action is used to merge sub-graphs for the secondary constituent classes.

FIG. 14 illustrates another methodology 1400 for work plan generation. The methodology 1400 begins with step 1402, where constituents are ordered in a given work product based at least in part on the frequency of use of the constituents for the given work product class. Next, one or more existing work products are analyzed 1404 to extract a set of relationships connecting constituents to end products. In step 1406, for each constituent in the given work product a relationship from the determined set of relationships is selected connecting the constituent to an end product. The selected relationships for each constituent are then combined 1408 in the given work product to determine the work plan.

It is important to note that one or more steps in FIGS. 11-14 and the methodologies described herein may be performed in parallel or in a different order. For example, steps 1204 and 1206 in FIG. 12 may be performed substantially simultaneously, or step 1206 may be performed before step 1204. Numerous other examples apply to the various steps in FIGS. 11-14 and the methodologies described herein.

FIG. 15 illustrates sub-graph or relationship combination for a given work plan. The representative sub-graphs for constituent 1 1520-1 and constituent 2 1520-2 comprises action 1 1540-1 followed by action 3 1540-3. The representative sub-graphs for constituent 3 1520-3, constituent 4 1520-4 and constituent 5 1520-5 comprise action 2 1540-2 followed by action 3 1540-3. Thus, the representative sub-graphs for constituent 1 1520-1 and constituent 2 1520-2 are merged on action 1 1540-1 and the representative sub-graphs constituent 3 1520-3, constituent 4 1520-4 and constituent 5 1520-5 are merged on action 2 1540-2. These combined sub-graphs are than merged on action 3 1540-3.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be but are not limited to, for example, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1-15, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-15, can also include, as described herein, providing a system, wherein the system includes distinct modules (e.g., modules comprising software, hardware or software and hardware).

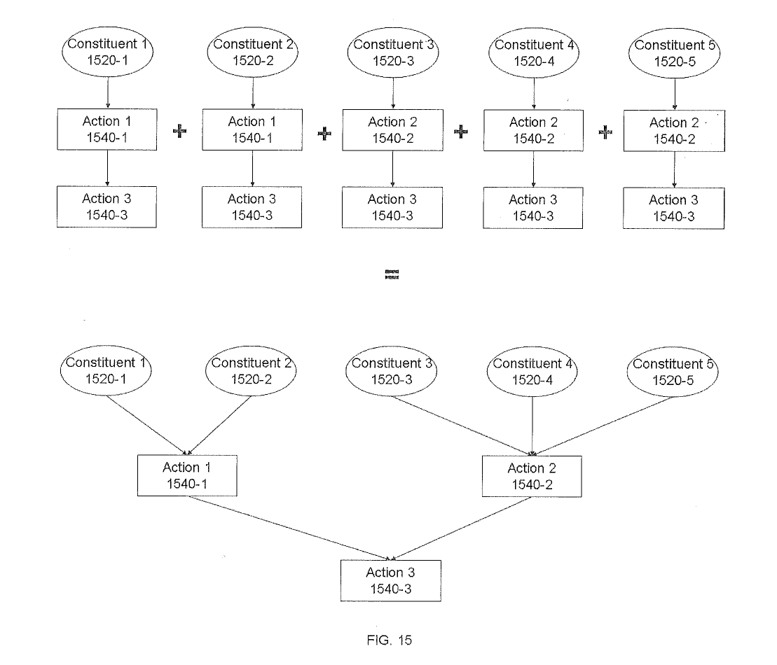

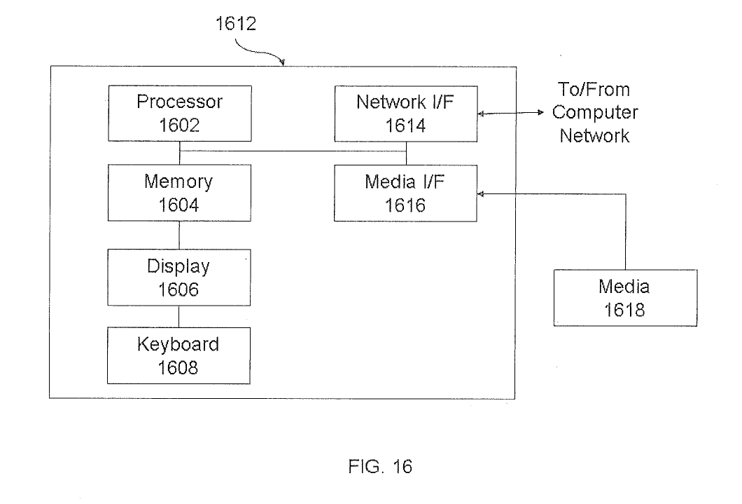

One or more embodiments can make use of software running on a general purpose computer or workstation. With reference to FIG. 16, such an implementation may employ, for example, a processor 1602, a memory 1604, and an input/output interface formed, for example, by a display 1606 and a keyboard 1608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to optionally include, for example, one or more mechanisms for inputting data to the processing unit (for example, keyboard or mouse), and one or more mechanisms for providing results associated with the processing unit (for example, display or printer).

The processor 1602, memory 1604, and input/output interface such as a display 1606 and keyboard 1608 can be interconnected, for example, via bus 1610 as part of data processing unit 1612. Suitable interconnections, for example, via bus 1610, can also be provided to a network interface 1614, such as a network card, which can be provided to interface with a computer network, and to a media interface 1616, such as a diskette or CD-ROM drive, which can be provided to interface with media 1618.

A data processing system suitable for storing and/or executing program code can include at least one processor 1602 coupled directly or indirectly to memory elements 1604 through a system bus 1610. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 1608 for making data entries; display 1606 for viewing data; a pointing device for selecting data; and the like) can be coupled to the system either directly (such as via bus 1610) or through intervening I/O controllers (omitted for clarity).

Network adapters such as a network interface 1614 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 1612 as shown in FIG. 16) running a server program. It will be understood that such a physical server may or may not include a display and keyboard. Further, it is to be understood that components may be implemented on one server or on more than one server.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An apparatus comprising:
a memory; and
a processor device operatively coupled to the memory and configured to:
select one or more constituents and one or more classes of work products;
analyze one or more existing work products to identify constituents frequently combined with the selected constituents and to identify constituents frequently used to create work products in the selected classes;
determine a set of constraints for combining constituents for the set of classes based at least in part on a result of the analysis of the one or more existing work products; and
generate one or more new work products in the set of classes using the set of constraints.

2. The apparatus of claim 1, wherein the processing device is further configured to evaluate the one or more new work products to obtain a score for each new work product, wherein the score for each new work product is based at least in part on a cost, novelty and quality of each new work product.

3. The apparatus of claim 1, wherein the set of constraints comprises a number of constituents included in a work product.

4. The apparatus of claim 3, wherein the number of constituents is user-defined.

5. The apparatus of claim 3, wherein the number of constituents is an average number and standard deviation of constituents in existing work products in the selected classes.

6. The apparatus of claim 1, wherein the set of constraints comprises at least one constraint identifying combinations of constituents which are invalid.

7. The apparatus of claim 1, wherein the set of constraints comprises at least one constraint identifying combinations of constituents which are invalid for a given one of the classes in the selected classes.

8. The apparatus of claim 1, wherein the set of constraints comprises at least one constraint identifying a set of frequently used constituents used for generating new work products in a given class, wherein a constituted is a frequently used constituent if a number of existing work products in the given class which use the constituent exceeds a frequency threshold.

9. The apparatus of claim 1, wherein each constituent is associated with at least one constituent class and wherein the set of constraints comprises at least one constraint identifying a number of constituents in a given constituent class to be used in generating new work products of a given class.

10. The apparatus of claim 1, wherein the processing device is further configured to:
for each constituent in a given one of the new work products, extract a set of relationships from the one or more existing products, wherein sub-graphs connect a constituent to an existing product with a sequence of actions;
for each constituent in the at least one new work product, select a given one of the sub-graphs; and
combine the selected sub-graphs to generate a work plan for creating the given new work product.

11. The apparatus of claim 10, wherein extracting the set of relationships further comprises grouping the sub-graphs.

12. The apparatus of claim 11, wherein each sub-graph has a starting constituent, each constituent is associated with at least one constituent class and sub-graphs are grouped based at least in part on the constituent class of the starting constituent of the sub-graphs.

13. The apparatus of claim 11, wherein sub-graphs are grouped based on a similarity of sequences of actions in the sub-graphs, wherein two or more sub-graphs are similar if a path edit distance between the sequences of actions in the sub-graphs is less than a distance threshold.

14. The apparatus of claim 10, wherein selecting a given one of the sub-graphs comprises selecting a sub-graph group and selecting a representative sub-graph from the selected sub-graph group.

15. The apparatus of claim 14, wherein each sub-graph group is assigned a frequency score based at least in part on the number of sub-graphs in each group, selecting the sub-graph group is based at least in part on the frequency scores and the representative sub-graph is a most common sub-graph in the selected sub-graph group.

16. The apparatus of claim 14, wherein the representative sub-graph is a sub-graph with a fewest number of actions in its sequence of actions in the selected sub-graph group.

17. The apparatus of claim 14, wherein combining the selected sub-graphs further comprises:
selecting a pair of constituents in the given new work product;
determining if the representative sub-graphs for the pair of constituents can be merged, wherein if the representative sub-graphs for the pair of constituents cannot be merged a new representative sub-graph for at least one constituent in the pair of constituents is selected until the representative sub-graphs for the pair of constituents can be merged or a threshold number of representative sub-graphs for the pair of constituents cannot be merged;
responsive to the determination, merging the pair of constituents by merging the representative sub-graphs of the first pair of constituents; and
repeating the selecting a pair of constituents, determining and merging until sub-graphs for all constituents in the given new work product have been merged to generate the work plan for the given new work product;
wherein a pair of representative sub-graphs can be merged when the sequences of actions in the pair of representative sub-graphs comprise a common merging action.

18. The apparatus of claim 17, wherein the threshold number includes all possible sub-graph combinations for the pair of constituents.

19. The apparatus of claim 17, wherein each constituent in the given new work product is assigned a priority level from a plurality of priority levels, and wherein the pair of constituents is selected according to the priority associated with the constituents in the given new work product.

20. The apparatus of claim 10, wherein the given new work product comprises a food dish and the at least one work plan comprises a recipe for the food dish.

21. The apparatus of claim 10, wherein the given new work product comprises a pharmaceutical and the at least one work plan comprises instructions for manufacturing the pharmaceutical.

22. The apparatus of claim 10, wherein the given new work product comprises a structure and the at least one work plan comprises a series of steps for building the structure.

23. The apparatus of claim 10, wherein the given new work product comprises a travel itinerary and the work plan comprises a list of activities to be performed in scheduling the travel itinerary.

24. An article of manufacture comprising a computer readable storage medium for storing computer readable program code which, when executed, causes a computer to:
select one or more constituents and one or more classes of work products;
analyze one or more existing work products to identify constituents frequently combined with the selected constituents and to identify constituents frequently used to create work products in the selected classes;
determine a set of constraints for combining constituents for the set of classes based at least in part on a result of the analysis of the one or more existing work products; and
generate one or more new work products in the set of classes using the set of constraints.
